(19) United States
(12) Patent Application Publication
(10) Pub. No.: US 2020/0029362 A1
(43) Pub. Date: Jan. 23, 2020

(54) WIRELESS DEVICES IMPLEMENTING AN ACCESS POINT OR A STATION, AND WIRELESS COMMUNICATION METHOD

(71) Applicant: MEDIATEK INC., Hsinchu City (TW)

(72) Inventors: Tsung-Hsuan WU, Hsinchu City (TW); Chao-Chun WANG, San Jose, CA (US); Yongho SEOK, San Jose, CA (US); Fu-Yu TSAI, Hsinchu City (TW)

(21) Appl. No.: 16/516,301

(22) Filed: Jul. 19, 2019

Related U.S. Application Data
(60) Provisional application No. 62/701,887, filed on Jul. 23, 2018.

(51) Int. Cl. H04W 74/08; H04L 1/00; H04L 1/18; H04L 5/00

(52) U.S. Cl. CPC H04W 74/0808; H04L 5/0055; H04L 1/18; H04L 1/003

(57) ABSTRACT

An asymmetric handshaking design between an access point (AP) and a station (STA) is introduced. An access point is controlled to transmit packets in a first packet format. In response to packets transmitted from the access point in the first packet format, a station is switched to use a second packet format to transmit packets to form asymmetric handshaking with the access point when the station fails to use the first packet format to answer the access point.

### CROSS REFERENCE TO RELATED APPLICATIONS

This Application claims the benefit of U.S. Provisional Application No. 62/701,887, filed on Jul., 23, 2018, the entirety of which is incorporated by reference herein.

### BACKGROUND OF THE INVENTION

### Field of the Invention

The invention relates to wireless Local Area Network (wireless LAN) techniques.

### Description of the Related Art

A wireless Local Area Network (wireless LAN) is a wireless communication network, which links two or more wireless devices within a limited area such as a home, school, computer laboratory, campus, office building etc. This gives users the ability to move around within the area and yet still be connected to a local area network. Through a gateway, a wireless LAN can also provide a connection to the wider Internet.

FIG. 1 depicts a wireless LAN connected to the Internet. Various wireless devices, like smartphones, printers, tablets, personal computers, laptops, and so on, are stations (STAs) connected to an access point (AP) 102 according to one of the 802.11 protocol family (e.g. Wi-Fi). The AP 102 is a networking hardware device that allows the connected Wi-Fi devices to connect to a wired network.

Frame collisions may occur if two wireless devices attempting to transmit data at exactly the same time. How to reduce frame collisions is an important topic. Even, in an actual environment, more than one access points may be set up within the same area. The multiple APs make the frame collision problem more serious. Frame collision reduction is important.

Furthermore, data rate optimization and network range extension are also important in this technical field.

### BRIEF SUMMARY OF THE INVENTION

An asymmetric handshaking design between an access point (AP) and a station (STA) is introduced when the STA is far away from the AP.

For downlink communication, the AP uses a first packet format to communicate with the STA, and the STA uses a second packet format to respond to the AP. Legacy wireless devices in the surroundings are compatible with the first packet format. In response to an RTS (request to send) packet transmitted by the AP in the first packet format, surrounding wireless devices give way to the downlink communication (from the AP to the STA). Specifically, the second packet format provides a more extended transmission range than the first packet format. The STA successfully responds to the AP by using the second packet format even if the STA is far away from the AP (e.g., the STA fails to use the first packet format to respond to the AP because the STA is less powerful to reach the AP by the first packet format).

In comparison with the second packet format, a higher data rate is provided by the first packet format that is adopted by the AP. High-speed downlink communication (from the AP to the STA), therefore, is achieved.

For uplink communication, the STA uses the second packet format to communicate with the AP, and the AP uses the first packet format to respond to the STA. Because the second packet format adopted by the STA is capable of long-distance transmission, data is successfully transmitted from the STA to the AP even if the STA is far away from the AP. In response to an RTS (request to send) packet transmitted by the STA in the second packet format, the AP transmits a CTS (clear to send) packet in the first packet format. Because the first packet format is recognizable to surrounding devices, surrounding devices give way to the uplink communication (from the STA to the AP).

In comparison with the second packet format, the transmission duration of the packets output by the AP in the first packet format is shorter. The asymmetric handshaking also speeds up the uplink communication (from the STA to the AP).

In an exemplary embodiment, a wireless device implementing a station is introduced. The wireless device has a transmitter, a receiver, and a controller. The controller controls the transmitter and the receiver. In response to packets transmitted from an access point in a first packet format and received by the receiver, the controller switches the transmitter to use a second packet format to transmit packets to form asymmetric handshaking with the access point when there has been a failure to answer the access point by the first packet format.

In another exemplary embodiment, a wireless device implementing an access point is introduced. The wireless device has a transmitter, a receiver, and a controller. The controller controls the transmitter and the receiver. The controller controls the transmitter to keep using a first packet format to transmit packets when the receiver receives packets transmitted from a station in a second packet format, to form asymmetric handshaking with the station.

In another exemplary embodiment, a wireless communication method is introduced, which includes the following steps: controlling an access point to transmit packets in a first packet format; and in response to packets transmitted from the access point in the first packet format, switching a station to use a second packet format to transmit packets to form asymmetric handshaking with the access point when the station fails to use the first packet format to answer the access point.

The second packet format may provide a wider coverage boundary than the first packet format.

In comparison with the second packet format, the first packet format may be compatible with older wireless communication protocols.

In comparison with the second packet format, a higher data rate is provided by the first packet format.

In comparison with the second packet format, packets transmitted in the first packet format may result in a shorter air time. In comparison with a symmetric handshaking that the access point uses the second packet format to answer the station, a shorter time interval is occupied by the packets (e.g. RTS for downlink, or CTS for uplink) transmitted by the access point.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 depicts a wireless LAN connected to the Internet;

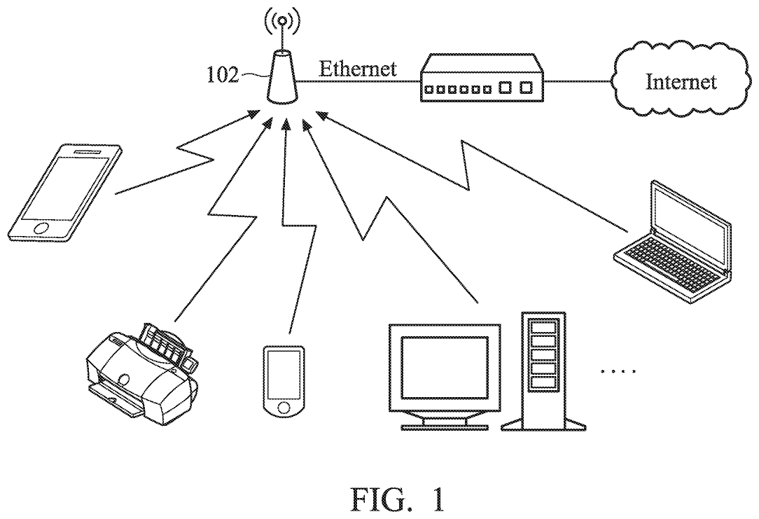

FIG. 2 is a block diagram depicting an access point (AP) 202 and a station (STA) 204 in accordance with an exemplary embodiment of the disclosure;

FIG. 3 shows the coverage boundary of the AP 202 and the STA 204;

FIG. 4 is a flowchart depicting how the STA 204 operates for the downlink communication in accordance with an exemplary embodiment of the present invention;

FIG. 5 is a timing scheme depicting the downlink communication based on the asymmetric handshaking;

FIG. 6 is a flowchart depicting how the STA 204 operates for the uplink communication in accordance with an exemplary embodiment of the present invention; and

FIG. 7 is a timing scheme depicting the uplink communication based on the asymmetric handshaking.

### DETAILED DESCRIPTION OF THE INVENTION

The following description shows embodiments of carrying out the invention. This description is made for the purpose of illustrating the general principles of the invention and should not be taken in a limiting sense. The scope of the invention is best determined by reference to the appended claims.

IEEE 802.11 is part of the IEEE 802 set of LAN protocols, and specifies the set of media access control (MAC) and physical layer (PHY) protocols for implementing Wi-Fi communication in various frequencies, including but not limited to 2.4, 5, 6, and 60 GHz frequency bands. Wi-Fi generations 1 to 6 refer to the 802.11b, 802.11a, 802.11g, 802.11n, 802.11ac, and 802.11ax protocols, in that order.

The same area may have multiple access points (APs) and multiple stations (STAs). Various protocol versions of the 802.11 family may be adopted by the different wireless devices (APs and STAs, implemented as consumer electronics and wireless modules within consumer electronics). A packet format that is interpretable to multiple-generation wireless devices is regarded as a first packet format. Another packet format that is introduced in the newer Wi-Fi generation is regarded as a second packet format. The second packet format provides an extended transmission range (a wider coverage boundary) than the first packet format. When a STA is far away from an AP and the STA fails to use the first packet format to reach the AP, the STA changes to use the second packet format to transmit packets. Note that the AP is kept using the first packet format that is recognizable to the other wireless devices in the surroundings. The other wireless devices in the surroundings, therefore, give way to the downlink and uplink between the AP and the STA.

In an exemplary embodiment, the first packet format is an 802.11a/g ofdm format, and the second packet format is an HE-SU-EXT PPDU format supported by an 802.11ax protocol. The 802.11a/g ofdm is interpretable to old version wireless devices in the surroundings and guarantees a high data rate. The HE-SU-EXT PPDU format is for long distance transmission. According to the asymmetric handshaking design of the present invention, an AP uses the 802.11a/g ofdm format to communicate with the STA, and the STA uses the HE-SU-EXT PPDU format to reach the AP. Frame collisions are considerably reduced. Data rate is optimized. Network range is extended.

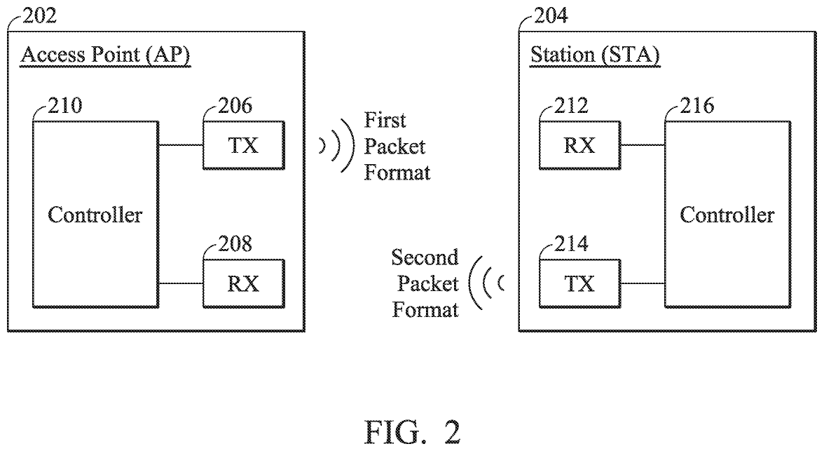

FIG. 2 is a block diagram depicting an access point (AP) 202 and a station (STA) 204 in accordance with an exemplary embodiment of the disclosure.

A transmitter (TX) 206, a receiver (RX) 208 and a controller 210 are provided on the AP 202. The controller 210 controls the transmitter 206 to transmit packets in the first packet format interpretable to the surrounding wireless devices. The surrounding wireless devices, therefore, give way to the AP 202 no matter what 802.11 protocol versions are adopted by the surrounding devices. The STA 204 has a receiver (RX) 212, a transmitter (TX) 214 and a controller 216. In response to the packets from the AP 202 and received by the receiver 212, the controller 216 controls the transceiver 214 to transmit packets. FIG. 2 shows that the controller 216 has switched to control the transmitter 214 to transmit packets in the second packet format because the response in the first packet format having failed. The STA 204 is far away from the AP 202, but the asymmetric handshaking (AP 202 transmitting packets in the first packet format and STA 204 responding packets in the second packet format) successfully establishes the link between the AP 202 and the STA 204.

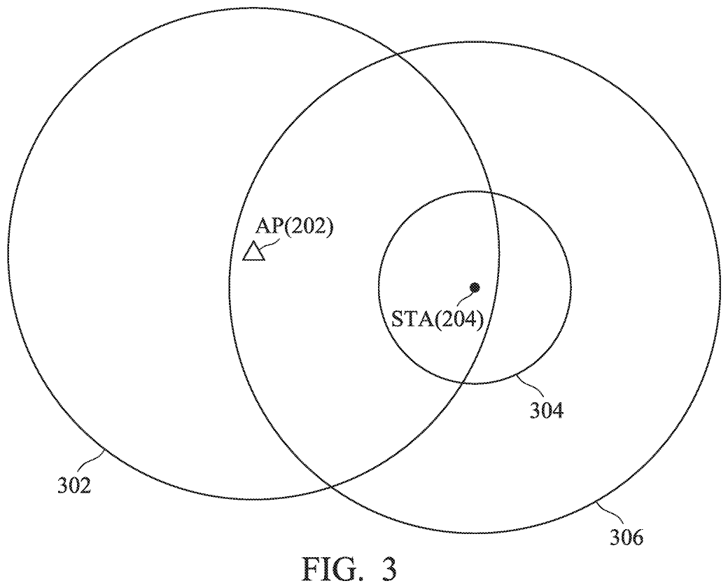

FIG. 3 shows the coverage boundary of the AP 202 and the STA 204. The coverage boundary of the AP 202 using the first packet format to transmit packages is labeled 302. The coverage boundary of the STA 204 using the first packet format to transmit packages is labeled 304. The coverage boundary of the STA 204 using the second packet format to transmit packages is labeled 306.

In comparison with the STA 204, the AP 202 is a high-power device. For the same first packet format, the coverage boundary 302 of the AP 202 is wider than the coverage boundary 304 of the STA 204. There is no problem for the AP 202 to reach the STA 204 by the first packet format. The AP 202 keeps using the first packet format for the compatibility with the surrounding wireless devices and the guaranteed data rate. In contrast, the STA 204 changes to use the second packet format for the extended transmission. The corresponding coverage boundary 306, as shown, successfully covers the AP 202 to build a link between the AP 202 and the STA 204.

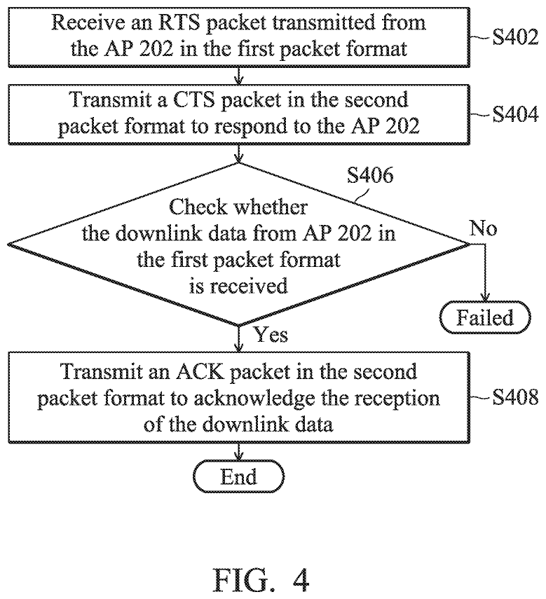

FIG. 4 is a flowchart depicting how the STA 204 operates for the downlink communication in accordance with an exemplary embodiment of the present invention. A state machine of the STA 204 has been switched to a state to use the second packet format to respond to the AP 202 that transmits packets in the first packet format. In an exemplary embodiment, the STA 204 switches to this state when packets transmitted in the first packet format from the STA 204 to the AP 202 are not answered. The STA 204 relies on the previous rate adaption state machine training result to decide whether to switch the transmission packet format.

In step S402, an RTS (request to send) packet transmitted from the transmitter 206 of the AP 202 in the first packet format is received by the receiver 212. According to the RTS packet, the controller 216 controls the transmitter 214 to perform step S404. The transmitter 214 transmits a CTS (clear to send) packet in the second packet format to respond to the AP 202. In step S406, the controller 216 checks whether the receiver 212 receives downlink data from AP 202 in the first packet format. If yes, step S408 is performed. The controller 216 controls the transmitter 214 to keep using the second packet format. The controller 216 controls the transmitter 214 to transmit an acknowledge package (ACK) in the second packet format to acknowledge the reception of the downlink data. Data is successfully transmitted from the AP 202 to the STA 204. Otherwise, the downlink communication fails.

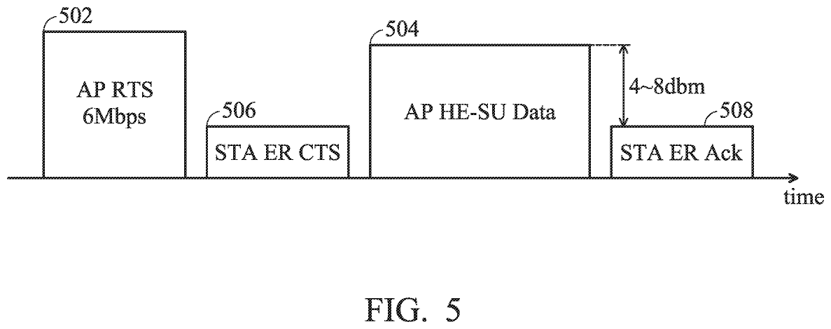

FIG. 5 is a timing scheme depicting the downlink communication based on the asymmetric handshaking.

The packets 502 and 504 transmitted by the AP 202 are in the first packet format, and the packets 506 and 508 transmitted by the STA 204 are in the second packet format. In this exemplary embodiment, a non-HT PPDU format (legacy) is used as the first packet format, and an HE ER SU PPDU format is used as the second packet format. The AP 202 transmits an RTS packet (502) at a data rate of 6 Mbps. The STA 204 returns a CTS packet (506) with extended range (ER). The AP 202 transmits HE-SU data packets 504 and thereby data is transmitted from the AP 202 to the STA 204. The STA returns an ER acknowledge packet 508 and the downlink communication ends. The power difference, 4 to 8 dbm, presents clearly that the downlink data rate (referring to the packet 504) is still quite impressive. At the AP 202 side, a packet duration occupied by the RTS packet 502 may be shorter than the symmetric handshaking technique (by which both the AP 202 and STA 204 use the ER packet format). The communication channel, therefore, is not overly occupied by the downlink communication (from the AP 202 to the STA 204). The communication channel may be shared with the surrounding wireless devices.

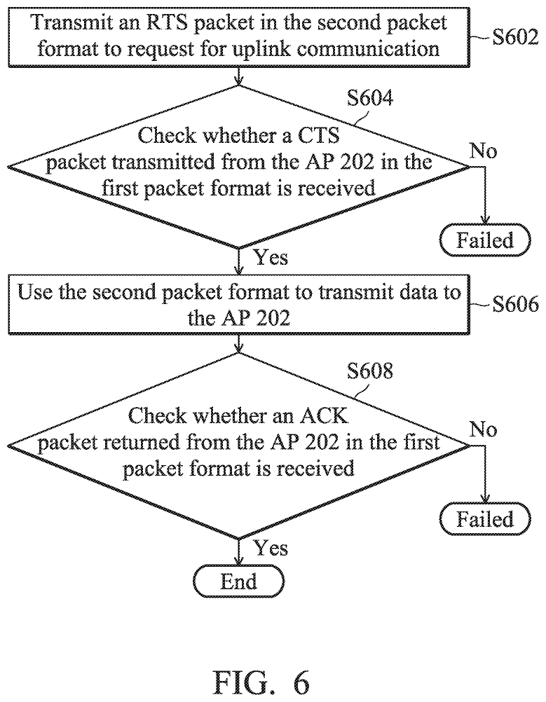

FIG. 6 is a flowchart depicting how the STA 204 operates for the uplink communication in accordance with an exemplary embodiment of the present invention. A state machine of the STA 204 has been switched to a state to use the second packet format to respond to the AP 202 that transmits packets in the first packet format. In an exemplary embodiment, the STA 204 switches to this state when packets transmitted in the first packet format from the STA 204 to the AP 202 are not answered. The STA 204 relies on the previous rate adaption state machine training result to decide whether to switch the transmission packet format.

In step S602, the controller 216 controls the transmitter 214 to transmit an RTS (request to send) packet in the second packet format to request for uplink communication. In step S604, the controller 216 checks whether a CTS packet transmitted from the AP 202 in the first packet format is received by the receiver 212. If no, the uplink communication fails. If yes, step S606 is performed. The controller 216 controls the transmitter 214 to use the second packet format to transmit data to the AP 202. In step S608, the controller 216 checks whether an acknowledge packet ACK returned from the AP 202 in the first packet format is received. If yes, the uplink communication ends. Otherwise, the uplink communication fails.

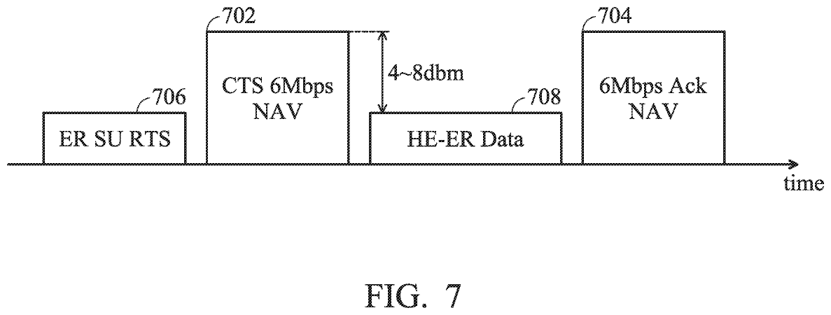

FIG. 7 is a timing scheme depicting the uplink communication based on the asymmetric handshaking.

The packets 702 and 704 transmitted by the AP 202 are in the first packet format, and the packets 706 and 708 transmitted by the STA 204 are in the second packet format. In this exemplary embodiment, a non-HT PPDU (legacy) format is used as the first packet format, and an HE ER SU PPDU (high efficiency, extended range and single user) format is used as the second packet format. The STA 204 transmits an ER SU RTS packet 706 to announce the data transmiting. The AP 202 returns a CTS packet 702 at a data rate of 6 Mbps with duration information NAV (network allocation vector). The STA 204 transmits HE-ER data packets 708 and thereby data is transmitted from the STA 204 to the AP 202. The AP 202 returns acknowledge packet 704 at a data rate of 6 Mbps with NAV. The uplink communication ends. The power difference, 4 to 8 dbm, presents clearly that the transmission durations of packets 702 and 704 are short. A duration field that the STA 204 indicates in the RTS packet 706 may be shorter than the symmetric handshaking technique (by which both the AP 202 and STA 204 use the ER packet format). The communication channel, therefore, is not overly occupied by the uplink communication (from the STA 204 to the AP 202). The communication channel may be shared with the surrounding devices. Specifically, the AP 202 preferably disables the ER CTS and ACK packets and usually uses the non-HT PPDU (legacy) format to transmit the CTS and ACK packets. Legacy devices (using the older versions of the 802.11 protocol family), therefore, can understand the CTS and ACK packets that the AP 202 output in the legacy format and, accordingly, update the NAV. Air time of uplink communication based on the asymmetric handshaking is reduced.

In some exemplary embodiments, the controller 210 of the access point 202 and the controller 216 of the station 204 use state machines to achieve the asymmetric handshaking.

In another exemplary embodiment, a wireless communication method is introduced, which includes the following steps: controlling an access point to transmit packets in a first packet format; and in response to packets transmitted from the access point in the first packet format, switching a station to use a second packet format to transmit packets to form asymmetric handshaking with the access point when the station fails to use the first packet format to answer the access point.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A wireless device, comprising:
a transmitter and a receiver; and
a controller, controlling the transmitter and the receiver, wherein:
in response to packets transmitted from an access point in a first packet format and received by the receiver, the controller switches the transmitter to use a second packet format to transmit packets to form asymmetric handshaking with the access point when there has been a failure to answer the access point by the first packet format.

2. The wireless device as claimed in claim 1, wherein:
the second packet format provides a wider coverage boundary than the first packet format.

3. The wireless device as claimed in claim 2, wherein:
in comparison with the second packet format, the first packet format is compatible with older wireless communication protocols.

4. The wireless device as claimed in claim 3, wherein:
in comparison with the second packet format, a higher data rate is provided by the first packet format.

5. The wireless device as claimed in claim 4, wherein:
in response to a request to send (RTS) packet transmitted from the access point in the first packet format, the controller performing asymmetric handshaking controls the transmitter to transmit a clear to send (CTS) packet in the second packet format.

6. The wireless device as claimed in claim 5, wherein:
in response to data packets transmitted from the access point in the first packet format, the controller performing asymmetric handshaking controls the transmitter to transmit an acknowledge packet in the second packet format.

7. The wireless device as claimed in claim 4, wherein:
the controller performing asymmetric handshaking controls the transmitter to transmit a request to send (RTS) packet in the second packet format to wait the access point to return a clear to send (CTS) packet in the first packet format.

8. The wireless device as claimed in claim 7, wherein:
in response to the clear to send (CTS) packet transmitted from the access point in the first packet format, the controller performing asymmetric handshaking controls the transmitter to transmit data to the access point in the second packet format.

9. The wireless device as claimed in claim 8, wherein:
after transmitting data to the access point in the second packet format, the controller waits the access point to return an acknowledge packet in the first packet format.

10. The wireless device as claimed in claim 9, wherein:
in comparison with the second packet format, packets transmitted in the first packet format result in a shorter air time; and
in comparison with a symmetric handshaking that the access point uses the second packet format to answer the wireless device, a shorter time interval is reserved by the clear to send (CTS) packet.

11. A wireless device, comprising:
a transmitter and a receiver; and
a controller, controlling the transmitter and the receiver,
wherein:
the controller controls the transmitter to keep using a first packet format to transmit packets when the receiver receives packets transmitted from a station in a second packet format, to form asymmetric handshaking with the station.

12. The wireless device as claimed in claim 11, wherein:
the second packet format provides a wider coverage boundary than the first packet format.

13. The wireless device as claimed in claim 12, wherein:
in comparison with the second packet format, the first packet format is compatible with older wireless communication protocols.

14. The wireless device as claimed in claim 13, wherein:
in comparison with the second packet format, a higher data rate is provided by the first packet format.

15. The wireless device as claimed in claim 14, wherein:
the controller performing asymmetric handshaking controls the transmitter to transmit a request to send (RTS) packet in the first packet format to wait the station to return a clear to send (CTS) packet in the second packet format.

16. The wireless device as claimed in claim 15, wherein:
in response to the clear to send (CTS) packet transmitted from the station in the second packet format, the controller performing asymmetric handshaking controls the transmitter to transmit data to the station in the first packet format.

17. The wireless device as claimed in claim 16, wherein:
after downlink transmission to the station in the first packet format, the controller waits the station to return an acknowledge packet in the second packet format.

18. The wireless device as claimed in claim 17, wherein:
in comparison with the second packet format, packets transmitted in the first packet format result in a shorter air time; and
in comparison with a symmetric handshaking that the wireless device uses the second packet format to answer the station, a shorter time interval is reserved by the request to send (RTS) packet.

19. The wireless device as claimed in claim 14, wherein:
in response to a request to send (RTS) packet transmitted from the station in the second packet format, the controller performing asymmetric handshaking controls the transmitter to transmit a clear to send (CTS) packet in the first packet format.

20. The wireless device as claimed in claim 19, wherein:
in response to data packets transmitted from the station in the second packet format, the controller performing asymmetric handshaking controls the transmitter to transmit an acknowledge packet in the first packet format.

21. A wireless communication method, comprising:
controlling an access point to transmit packets in a first packet format; and
in response to packets transmitted from the access point in the first packet format, switching a station to use a second packet format to transmit packets to form asymmetric handshaking with the access point when the station fails to use the first packet format to answer the access point,
wherein:
the second packet format provides a wider coverage boundary than the first packet format;
in comparison with the second packet format, the first packet format is compatible with older wireless communication protocols; and
in comparison with the second packet format, a higher data rate is provided by the first packet format.

22. The wireless communication method as claimed in claim 21, further comprising:
based on the asymmetric handshaking, controlling the access point to transmit a request to send (RTS) packet in the first packet format to wait the station to return a clear to send (CTS) packet in the second packet format;
in response to the clear to send (CTS) packet transmitted from the station in the second packet format, controlling the access point to transmit data to the station in the first packet format; and
after transmitting data to the station in the first packet format, controlling the station to return an acknowledge packet in the second packet format.

23. The wireless communication method as claimed in claim 22, wherein:
in comparison with the second packet format, packets transmitted in the first packet format result in a shorter air time; and
in comparison with a symmetric handshaking that the access point uses the second packet format to answer the station, a shorter time interval is reserved by the request to send (RTS) packet.

24. The wireless communication method as claimed in claim 21, further comprising:
based on the asymmetric handshaking, controlling the station to transmit a request to send (RTS) packet in the second packet format to wait the access point to return a clear to send (CTS) packet in the first packet format;
in response to the clear to send (CTS) packet transmitted from the access point in the first packet format, controlling the station to transmit data to the access point in the second packet format; and
after transmitting data to the access point in the second packet format, controlling the access point to return an acknowledge packet in the first packet format.

25. The wireless communication method as claimed in claim 24, wherein:
in comparison with the second packet format, packets transmitted in the first packet format result in a shorter air time; and
in comparison with a symmetric handshaking that the access point uses the second packet format to answer the station, a shorter time interval is reserved by the clear to send (CTS) packet.
